(19) United States
(12) Patent Application Publication
(10) Pub. No.: US 2025/0110456 A1
(43) Pub. Date: Apr. 3, 2025

(54) COGENERATION OPTIMIZATION MODEL IN UPSTREAM CRUDE PROCESSING FACILITY

(71) Applicant: Saudi Arabian Oil Company, Dhahran (SA)

(72) Inventors: Kamarul Ariffin Amminudin, Dhahran (SA); Abdullah A. Alzahrani, Riyadh (SA)

(21) Appl. No.: 18/477,086

(22) Filed: Sep. 28, 2023

(51) Int. Cl. G05B 13/04; G06Q 10/0631

(52) U.S. Cl. CPC G05B 13/048; G06Q 10/06315

(57) ABSTRACT

A method for developing a model to optimize operations for a cogen facility is provided. The method includes collecting data on the operation of the cogen facility and creating an objective function to minimize total operating cost of the cogen facility, wherein the objective function is based, at least in part, on a fuel cost and a net power cost. An output is provided from the objective function, wherein the output is used to control a mixture of gas turbines used in the cogen facility and steam generation rates.

### TECHNICAL FIELD

This disclosure relates to methods of developing a model for optimizing the operating parameters for a cogen facility associated with a crude processing facility.

### BACKGROUND

Cogeneration plants, termed cogen facilities, are plants that generate both electrical power and heat. They are often located in industrial areas, such as near refineries and chemical plants, for which they can provide both electrical power and steam. Cogen facilities increase the efficiency of power generation and steam production as the production of each can be made from the same fuel source, which is converted to power, for example, in a gas turbine. The waste heat from this power conversion is then used to generate steam. Prior to cogeneration, industries relied on a lower efficiency process in which steam was generated in a dedicated boiler, and electrical power was imported from an electrical grid. As cogeneration is getting more economically attractive, optimizing cogeneration design and operation has become one of the key initiatives in the operating facilities, for example, to lower carbon oxides production.

Optimization of a cogeneration system is a complex task that poses many parameters that need to be determined. The interaction between parameters make an intuitive solution difficult or impossible. Creating a cogeneration model that mimics the actual operation will improve design and operation of cogeneration facilities.

### SUMMARY

An embodiment described herein provides a method for developing a model to optimize operations for a cogen facility. The method includes collecting data on the operation of the cogen facility and creating an objective function to minimize total operating cost of the cogen facility, wherein the objective function is based, at least in part, on a fuel cost and a net power cost. An output is provided from the objective function, wherein the output is used to control a mixture of gas turbines used in the cogen facility and steam generation rates.

### BRIEF DESCRIPTION OF DRAWINGS

FIG. 1 is a drawing of a cogen facility that can be used in refineries and petrochemical plants.

FIG. 2 is a drawing of a cogen system that is used in upstream crude processing facilities.

FIG. 3 is a plot of a linear correlation between GTG power generation and GTG fuel gas consumption.

FIG. 4 is a plot of a linear correlation between steam generation rate and GTG fuel gas consumption.

FIG. 5 is a plot of a linear correlation between the seawater injection rate from GT 1 pump and the GT fuel gas consumption.

FIG. 6 is a plot of a linear correlation between the HRSG steam rate from GT1 vs the GT1 fuel gas.

FIG. 7 is a plot of the boiler steam generation rate versus the boiler fuel gas consumption.

FIG. 8 is a schematic diagram of an optimization framework that can be used to apply the models described herein to operation of a cogen facility.

FIG. 9 illustrates a template that summarizes the outputs of the various optimization scenarios at the given production and seawater injection rates.

### DETAILED DESCRIPTION

A method for developing a cogeneration operating model is provided. The operating model is a performance model of a cogeneration (cogen) facility, which allows the determination of operational adjustments. The operating model includes the inputs and outputs for the components of the cogen facility used in the refinery, including the gas turbine generators (GTG), heat recovery steam generators (HRSG), steam turbine generators (STG), gas turbines (GT) use for powering pumps, boilers, and let down stations.

The operating model is based on the actual performance data of the cogen facility and is continuously validated to ensure the model reflects the reality on the site. The operating model is integrated with the rest of the operating units that make up the cogen, such as the steam condensate system, via a comprehensive mass and energy balance of the whole cogen system.

The operating model may be used for optimization purposes with the objective function selected to minimize operating costs and optimize energy intensity (EI) for various production and water injection cases. The output of the optimization model can be used to determine the numbers of gas turbines or boilers to run while keeping the operating constraints within the limits as defined in the model. The operating model has used to optimize various operating scenarios at a plan, which contributed to an EI improvement of 1-2% without incurring any capital cost.

Operating model described herein is directed to cogeneration facilities used in upstream crude oil processing, where the cogeneration operation depends on the crude production requirements, for example, based on seawater injection rates. Thus, the model accounts for the relevant parameters for crude production, including, injection rates, power demands, steam demands, and the like.

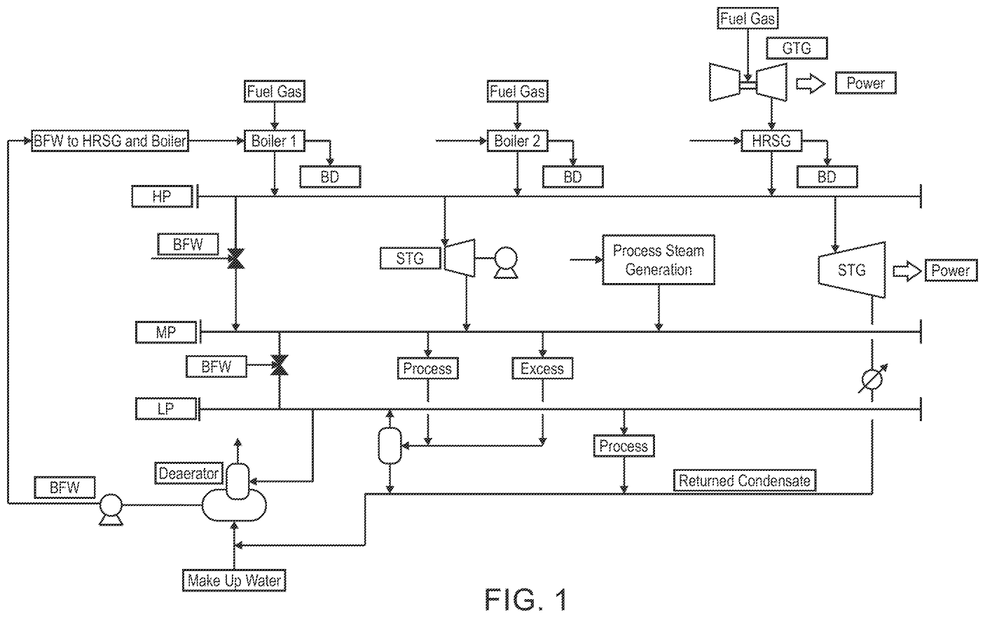

FIG. 1 is a drawing of a cogen facility that can be used in refineries and petrochemical plants. While cogen facilities are known, the configuration of the cogen facilities can be varied to modify the power and steam output. The objective is to generate power and steam for the plant use, while minimizing operating costs. In this example, the power is generated by gas turbine generators (GTG) and steam turbine generators (STG). To maximize the efficiency of the cogen system, a waste heat recovery unit or heat recovery steam generator (HRSG) is provided. In this configuration, boilers, and the output from the HRSG are used to feed a high pressure (HP) steam header. The HP steam is consumed by the STG for power generation and is also fed to a plant header for plant demands for HP steam. In some applications, the power generated in the STG is used to drive the process units such as the pumps, valves, and the like.

There are various types of boilers in use in cogen facilities. The most common boilers are either fired by fuel gas (BOILER 2) or fuel oil (BOILER 1). For most cases, the boilers are the primary source of steam. Steam can be generated according to its respective pressure level which covers, in terms of relative of importance, HP steam, medium pressure (MP) and low pressure (LP) steam. The higher the steam pressure, the higher its value will be, especially for electrical power generation.

The steam condensate recovered from the cogen plant is then recycled. Before reuse, the steam condensate (shown as returned condensate) is treated via a deaerator to remove any oxygen. As there are condensate losses in the system, some amount of make-up water, fed to the deaerator in this example, is used to ensure the water balance in the cogen system is intact.

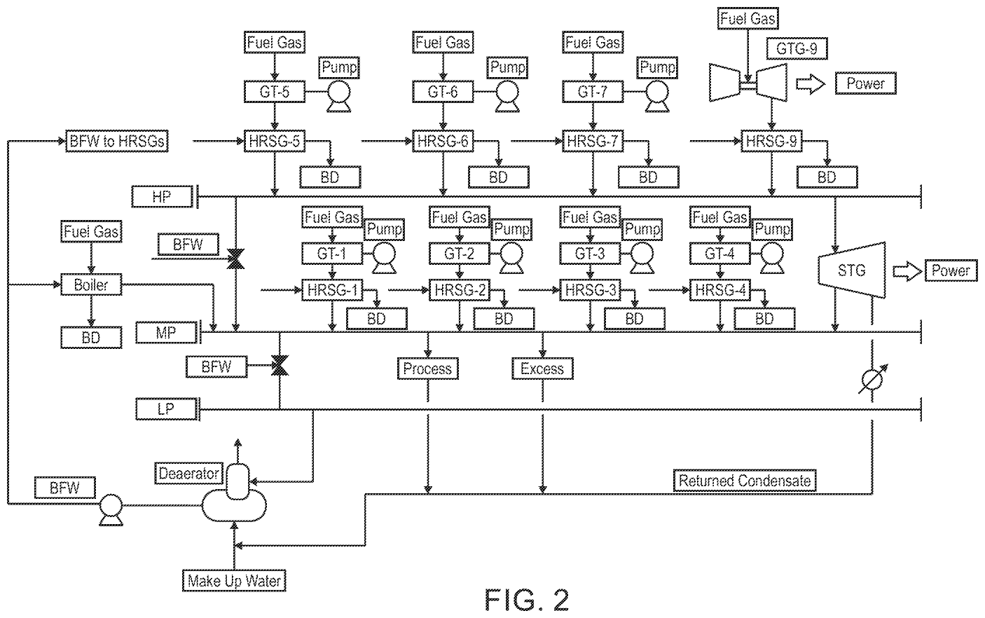

FIG. 2 is a drawing of a cogen system that is used in upstream crude processing facilities. The upstream cogen system is somewhat different from the refinery cogen system shown in FIG. 1. The main feature of the upstream cogen system is the use of gas turbines (GT) to drive seawater injection pumps (labeled as pump). Similar to the cogen system used in the refinery case, the GT are equipped with HRSG to capture waste heat for steam generation. Since the water injection system is more important than power generation for the crude processing system, the boiler utilization will be lower than the case shown in FIG. 1, as the boilers provide a supplementary load rather than the base load used in the refinery and the petrochemical plants. The optimization model described herein accounts for the unique features of the upstream cogen facility.

Optimization models for cogen facilities have been studied and are deployed in many facilities worldwide. These models have become increasingly important as businesses focus on decarbonization efforts and commercial interest. This kind of model which has been used to understand the various interactions among the equipment in the cogen facilities and identify cost reduction opportunities in the cogen system, assess process modification benefits, and provide reliable energy cost accounting especially with the various steam levels.

However, the upstream cogen facilities, as shown in FIG. 2, have the added complexity of the seawater injection requirement in the optimization along with the production rates. This is particularly true as the water injection requirement will determine the number of gas turbines to run. The operating model is thus needed to determine the optimum operating condition for the given production and water injection rates while maximizing the value creation from the cogen such as minimizing operating cost of the cogen system as a whole.

### Examples

### Model Development

The development of the operating model begins with the modeling of the individual equipment within the cogen system. The operating model is developed based on the actual performance of the equipment. Accordingly, historical data of the past few months was extracted from the equipment. The reason for using shorter time period, as opposed to data over a year or longer timeframe, is to realistically model the current performance of the operation in the immediate future. The operating model tends to be more reliable for predicting in the short term rather than the long term, as the model is regressed more reliably at the most recent performance. On the performance aspect, the trend was observed to identify appropriate correlations. The objective is to have a linear correlation for the relevant performance. The model is then revalidated against the actual performance. Having a linear model reduces the complexity of solving an optimization problem.

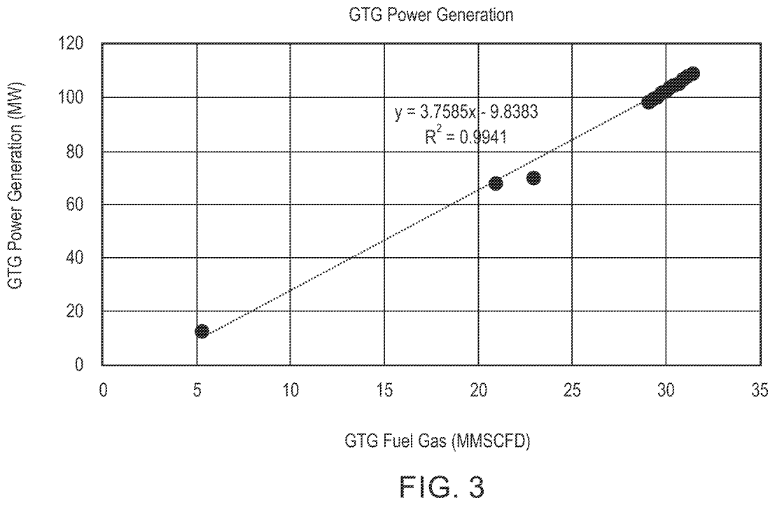

FIG. 3 is a plot of a linear correlation between GTG power generation and GTG fuel gas consumption. The first model developed is a correlation between the power generation of the GTG and the fuel gas consumption. A linear correlation is shown in Equation 1:

$$GTG power ( MW ) = 3.7585 \times ( GTG fuel gas ) - 9.8383 \qquad ( EQN . 1 )$$

This model was validated against the actual performance, indicating an excellent fit. Accordingly, this model could then be used for each of the gas turbine generators in the cogen facility.

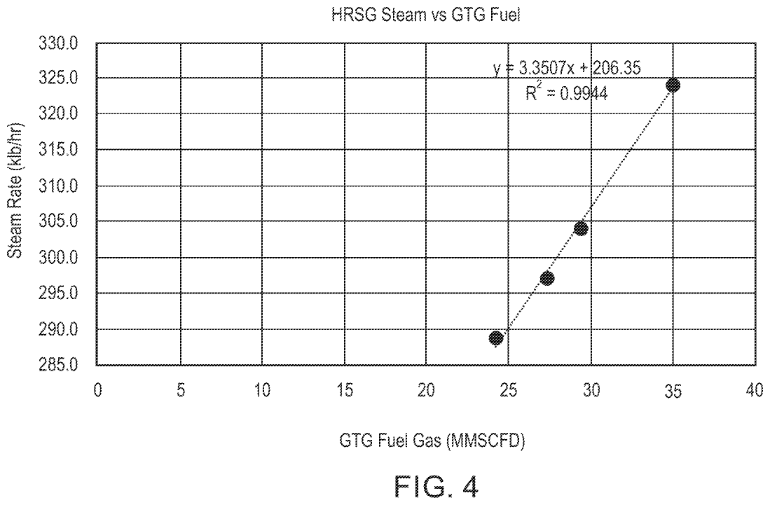

FIG. 4 is a plot of a linear correlation between steam generation rate and GTG fuel gas consumption. The second model developed is a correlation between the HRSG GTG steam rate and the GTG fuel gas consumption. A linear correlation is shown in Equation 2:

$$GTG HRSG steam rate ( kg lb / hr ) = 3.3507 \times ( GTG fuel gas ) + 206.35 \qquad ( EQN . 2 )$$

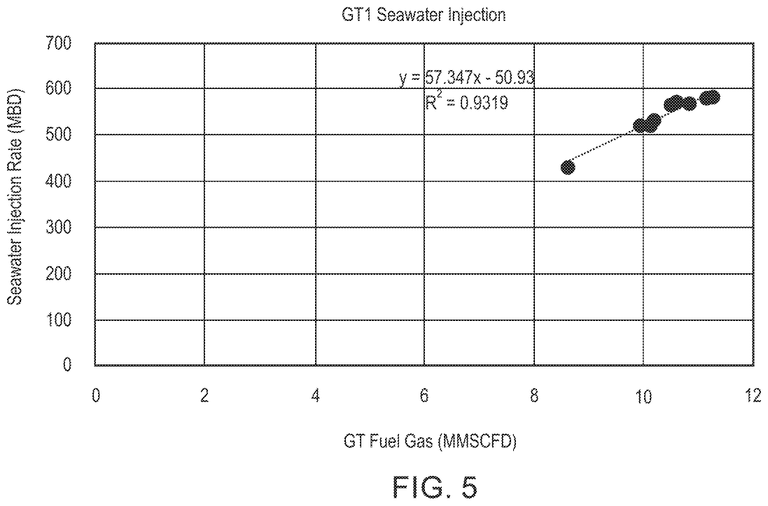

FIG. 5 is a plot of a linear correlation between the seawater injection rate from GT 1 pump and the GT fuel gas consumption. The third model developed is a correlation between the seawater injection rate from a GT pump and the fuel gas consumption of the gas turbine for the pump. This correlation was developed for a single gas turbine (GT1) used to power an injection pump but applies to other GT driven pumps in the system. The linear correlation is shown in Equation 3:

$$Seawater rate GT 1 = 57.347 \times ( GT 1 fuel gas ) - 50.93 \qquad ( EQN . 3 )$$

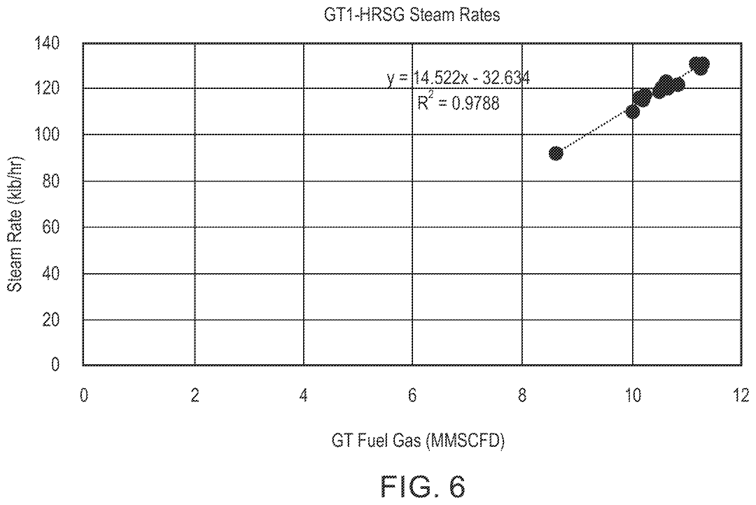

FIG. 6 is a plot of a linear correlation between the HRSG steam rate from GT1 vs the GT1 fuel gas. The fourth model developed is a correlation between the HRSG steam rate from the GT1 versus the fuel gas consumption of GT1. This correlation was developed for a single gas turbine (GT1) used to power an injection pump but applies to other GT driven pumps in the system. The linear correlation is shown in Equation 4:

$$Steam rate for GT 1 ‐ HRSG 1 = 14.522 \times ( GT 1 fuel gas ) - 32.634 \qquad ( EQN . 4 )$$

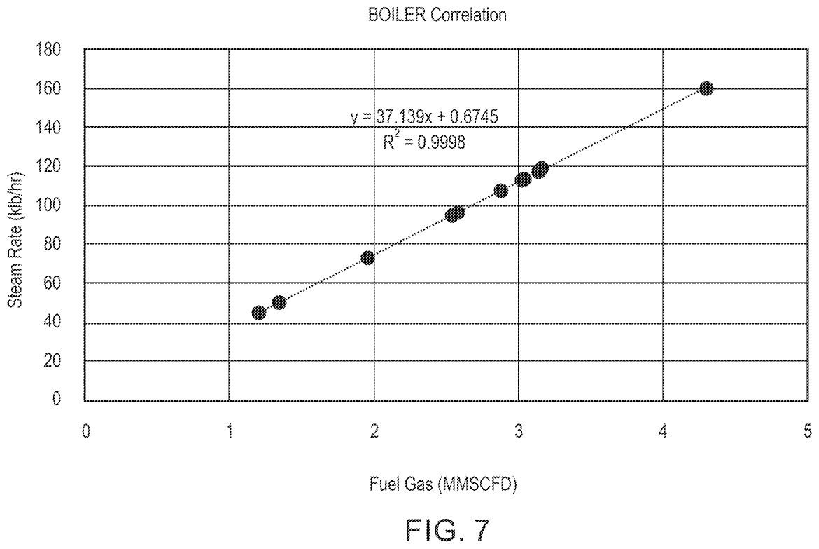

FIG. 7 is a plot of the boiler steam generation rate versus the boiler fuel gas consumption. The fifth model developed is a correlation between the steam generated in a boiler and the fuel gas consumption of the boiler. The same correlation can be developed for the other boilers in the system. The linear correlation is shown in equation 5:

$$Steam rate for boiler = 37.139 \times ( GT 1 fuel gas ) + 0.6745 \qquad ( EQN . 5 )$$

As for the steam turbine model, it was based on the standard thermodynamic correlation model involving enthalpy steam properties and relevant isentropic efficiency.

A sixth model was developed to account for number of gas turbines or boilers in operation. This was a logical model based on a binary variable (0 or 1) used to represent whether a gas turbine was in use or not. This is part of the overall optimization model framework. The model assigns Z1, Z2, Z3, Z4, Z5, Z6, and Z7 as binary variables to each of the 7 gas turbines in the cogen facility. Thus, the number of gas turbines in operation is represented by equation 6:

$$Z 1 + Z 2 + Z 3 + Z 4 + Z 5 + Z 6 + Z7 = No . of GT in operation \qquad ( EQN . 6 )$$

The number of gas turbines to be operated for the given total seawater injection requirement can be determined by dividing the total injection requirement value with the capacity of the gas turbine loading, for example, the water injection rate for the gas turbine.

The optimization model can then determine which machines to run from Z1 to Z7, to satisfy the requirement of number of gas turbines in operation. In some cases, a user can dictate the specific machines to run, for example, the need to run gas turbines linked to an HRSG to produce either HP steam or MP steam. For example, the gas turbines labeled Z1, Z2, Z3 and Z4 may produce MP steam, while the gas turbines labeled Z5, Z6, and Z7 may produce HP steam. Accordingly, if only 2 MP steam gas turbines were to be run, the model is expressed as shown in equation 7:

$$Z 1 + Z 2 + Z 3 + Z 4 = 2 \qquad ( EQN . 7 )$$

Similarly for the HP steam gas turbines, assuming only one machine is required, this model is expressed as shown in equation 8:

$$Z 5 + Z 6 + Z 7 = 1 \qquad ( EQN . 8 )$$

The sum of Equations 7 and 8 then gives a total number of gas turbines in operation, e.g., three in this case.

The above-mentioned concept can be applied equally well for the given number of boilers to run. In addition, this kind of logical modelling can be used to reflect the specific selection of the equipment to run to account for reliability issues or downtime of the other equipment.

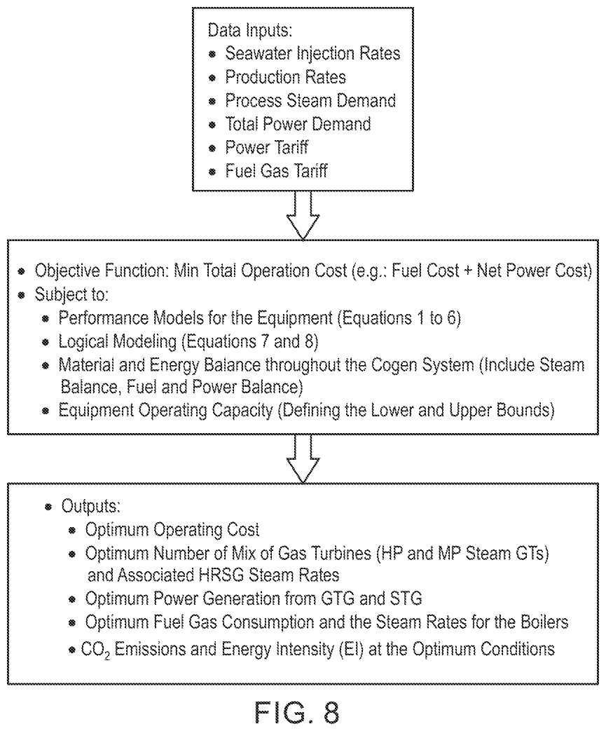

FIG. 8 is a schematic diagram of an optimization framework that can be used to apply the models described herein to operation of a cogen facility. The framework illustrates the data inputs, the optimization model, and the outputs. The data inputs mainly include related data of production and water injection requirement.

The optimization framework is the engine behind the modeling work where all the models developed will then be subjected to the established optimization algorithm. Since the model is mixed with linear and non-linear components along with binary (0 and 1 variables), the optimization algorithm used is the Mixed Integer Non-Linear Programming (MINLP). For example, the non-linear model typically relates to the cogeneration efficiency calculation as shown in equation 9.

$$Power import efficiency = ( power generation - power demand ) / cogen efficiency \qquad ( EQN . 9 )$$

In equation 9, cogen efficiency is a non-linear equation having the form shown in equation 10.

$$cogen efficiency = power generation / cogen fuel gas consumption . \qquad ( EQN . 10 )$$

Similarly, the binary variables are used to impose the existence of a unit or otherwise. As an illustration, two models shown in equations 11 and 12 show linear models with a binary variable, A1.

$$BOILER STEAM = 35.1 * BOILER FUEL - 1.7 * A 1 \qquad ( EQN . 11 )$$

$$BOILER STEAM < 30000 * A 1 \qquad ( EQN . 12 )$$

If A1 is 1, indicating that a unit exists, the boiler steam will show its corresponding figures based on the optimum boiler fuel variable. The second model above ensures that boiler steam is within a boundary or limit. However, if A1 is 0, indicating that no unit exists, the second model should have the boiler steam ZERO as the right-hand side of the second model is already ZERO. Thus, the Boiler Fuel will be ZERO as well.

The objective function is used to minimize operating cost, which includes the fuel gas cost and net power cost (difference between power import and export), while honoring the constraints, defined by performance models, logical modelling, material, and energy balance around the cogen system and the equipment capacity. The objective function serves as a basis for optimization criteria. An example of an objective function that may be used is the operation cost optimization form showed in equation 13.

$$Total Cost Annualized = Fuel gas cost * Heating value * Annual days * ( Fuel gas consumed in the gas turbines , boilers , and Gas turbine generator ) + Freshwater cost * Annual days * 24 * Make up water + ( Power demand - power generation ) * 24 * Annual days * Power tariff . \qquad ( EQN . 13 )$$

There are various optimization packages can be used for this purpose, such as GAMS (General Algebraic Modelling System) or MATLAB. These are the mathematical programming software packages that are used to solve optimization problems. In this embodiment, the models were coded in GAMS package, either in Academic, Demo version or Commercial License, to define the objective function and constraint models (performance models, logical models, capacity, material, and energy balances) respectively. These models are then solved through the MINLP algorithm to determine the optimized variables. Depending on the size and the quality of the models, the solution can be generated within several seconds. In this case, the linear models are much quicker and easy to solve as opposed to the very non-linear models. Non-linear models are known to cause optimization convergence problem if appropriate or reasonable variable initialization is not given to the MINLP solver. Hence, it is always advantage to the user to develop linear models.

To demonstrate the strength of the model, a validation exercise was carried out to compare the actual performance of the cogen facility with the modeled performance. It was found that the average model error was well below 2%. Following this validation exercise, the operating model was deemed fit to work on optimization, where any operating scenarios and/or what-if scenarios can be analyzed.

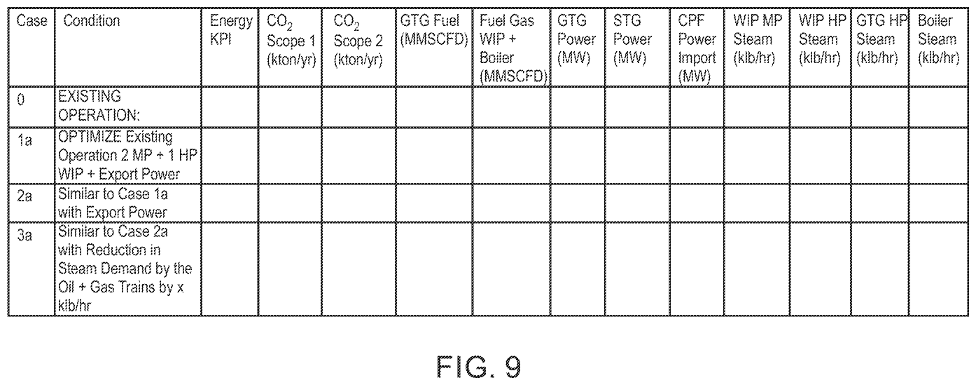

FIG. 9 is a template that summarizes the outputs of the various optimization scenarios at the given production and seawater injection rates. Operating personnel can use the template to optimize the performance of the cogen facility. If the objective is to improve the energy intensity, the template will show at what operating scenario that the lowest EI can be achieved. The table can also be used by the operating personnel to plan improvements, for example, by allowing the modeling of various scenarios.

### Embodiments

An embodiment described herein provides a method for developing a model to optimize operations for a cogen facility. The method includes collecting data on the operation of the cogen facility and creating an objective function to minimize total operating cost of the cogen facility, wherein the objective function is based, at least in part, on a fuel cost and a net power cost. An output is provided from the objective function, wherein the output is used to control a mixture of gas turbines used in the cogen facility and steam generation rates.

In an aspect, combinable with any other aspect, the method includes collecting data on seawater injection rates.

In an aspect, combinable with any other aspect, the method includes collecting data on production rates.

In an aspect, combinable with any other aspect, the method includes collecting data on steam demand from the cogen facility.

In an aspect, combinable with any other aspect, the method includes collecting data on power demand from the cogen facility.

In an aspect, combinable with any other aspect, the method includes collecting data on the power cost for the cogen facility.

In an aspect, combinable with any other aspect, the method includes collecting data on the fuel gas cost for the cogen facility.

In an aspect, combinable with any other aspect, the method includes the objective function is based, at least in part, on a performance model for equipment in the cogen facility.

In an aspect, combinable with any other aspect, the objective function is based, at least in part, on a logical model of the cogen facility.

In an aspect, combinable with any other aspect, the objective function is based, at least in part, on a material and energy balance in the cogen facility.

In an aspect, combinable with any other aspect, the objective function is based, at least in part, on operating capacity of equipment in the cogen facility.

In an aspect, combinable with any other aspect, the output includes an operating cost for the cogen facility.

In an aspect, combinable with any other aspect, the output includes a target for power generation.

In an aspect, combinable with any other aspect, the output includes a fuel consumption rate.

In an aspect, combinable with any other aspect, the output includes a steam production rate.

In an aspect, combinable with any other aspect, the output includes CO2 emission from the cogen facility.

In an aspect, combinable with any other aspect, the output includes an energy intensity for the cogen facility.

Other implementations are also within the scope of the following claims.

What is claimed is:

1. A method for developing a model to optimize operations for a cogen facility, comprising:
collecting data on the operation of the cogen facility;
creating an objective function to minimize total operating cost of the cogen facility, wherein the objective function is based, at least in part, on a fuel cost and a net power cost; and
providing an output from the objective function, wherein the output is used to control a mixture of gas turbines used in the cogen facility and steam generation rates.

2. The method of claim 1, comprising collecting data on seawater injection rates.

3. The method of claim 1, comprising collecting data on production rates.

4. The method of claim 1, comprising collecting data on steam demand from the cogen facility.

5. The method of claim 1, comprising collecting data on power demand from the cogen facility.

6. The method of claim 1, comprising collecting data on the power cost for the cogen facility.

7. The method of claim 1, comprising collecting data on the fuel gas cost for the cogen facility.

8. The method of claim 1, wherein the objective function is based, at least in part, on a performance model for equipment in the cogen facility.

9. The method of claim 1, wherein the objective function is based, at least in part, on a logical model of the cogen facility.

10. The method of claim 1, wherein the objective function is based, at least in part, on a material and energy balance in the cogen facility.

11. The method of claim 1, wherein the objective function is based, at least in part, on operating capacity of equipment in the cogen facility.

12. The method of claim 1, wherein the output includes an operating cost for the cogen facility.

13. The method of claim 1, wherein the output includes a target for power generation.

14. The method of claim 1, wherein the output includes a fuel consumption rate.

15. The method of claim 1, wherein the output includes a steam production rate.

16. The method of claim 1, wherein the output includes CO2 emission from the cogen facility.

17. The method of claim 1, wherein the output includes an energy intensity for the cogen facility.
